(19) United States
(12) Patent Application Publication
(10) Pub. No.: US 2003/0234504 A1
(43) Pub. Date: Dec. 25, 2003

(54) Wheel suspension for a motor vehicle

(75) Inventor: Michael Johannes Frantzen, Aachen (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Global Technologies, Inc., Dearborn, MI (US)

(21) Appl. No.: 10/248,063

(22) Filed: Dec. 13, 2002

(30) Foreign Application Priority Data
Dec. 14, 2001 (EP) 01129784.3

(51) Int. Cl. B62D 7/18

(52) U.S. Cl. 280/93.512

(57) ABSTRACT

The invention relates to a wheel suspension for a motor vehicle, the steering knuckle (1) being mounted on a carrier (3) in such a way that it can rotate about a vertical axis (6). In this arrangement, the vertical axis (6) passes approximately through the center (Z) of the wheel. The carrier (3) is furthermore coupled at its lower end to the body or to a subframe, preferably via a link (8). Instead of the steering knuckle (1) it is also possible for a spindle to be mounted so as to be rotatable about a vertical axis through the wheel center.

### BACKGROUND OF INVENTION

1. Technical Field

The present invention relates generally to a wheel suspension for a motor vehicle containing a bearing element for the wheel axle.

2. Background

A wheel suspension of the type stated at the outset is known from DE 44 09 571 A1. This is what is known as a McPherson-strut axle with a steering knuckle on which a wheel of the motor vehicle is mounted by means of its axle. The steering knuckle is furthermore coupled to the body by a spring strut comprising a damper piston and a coil spring and by a transverse link. To reduce the tendency of such a wheel suspension for steering-wheel vibration and rough running, DE 44 09 571 A1 makes provision for the damper cylinder to be mounted securely against rotation, it being possible to achieve this, in particular, by means of a link additionally attached to it and coupled to the body.

### SUMMARY OF INVENTION

The wheel suspension according to the invention, which is intended for a motor vehicle, contains a bearing element for the axle of the wheel to be suspended. The wheel can be a driven or an undriven front wheel or rear wheel of the motor vehicle. The bearing element can, in particular, be a steering knuckle or a spindle. According to the invention, the bearing element is mounted on a carrier in such a way that it can rotate relative to an essentially vertical axis, the vertical axis passing close to the wheel center or central point. This is intended, in particular, to include the case where the vertical axis passes through the wheel center.

The mounting of the bearing element in such a way, in accordance with the invention, that it is rotatable about the vertical axis explained introduces an additional degree of freedom. The braking-force lever arm, the acceleration-force lever arm and the impact radius can thus be adjusted arbitrarily, preferably being minimized. In this way, the production and transmission of disturbing vibrations and forces is minimized.

The carrier of the bearing element can furthermore be connected at its lower end, in a joint, to a link coupled to the body. The joint is, in particular, a hinge joint. The fixing of the lower end of the carrier in a joint reduces its degrees of freedom accordingly and makes the system more rigid.

The carrier can furthermore be coupled directly or indirectly to the body by means of a spring strut. As is known, a spring strut comprises a damper piston and a coil compression spring and ensures damped, flexible support of the wheel on the body.

### BRIEF DESCRIPTION OF DRAWINGS

FIG. 1 shows schematically a side view of a wheel suspension according to the invention, the suspension being of modified McPherson type.

FIG. 2 shows a more detailed perspective representation of the wheel suspension.

FIG. 3 shows a schematic representation of a wheel suspension according to the invention of the type with two transverse links.

FIG. 4 shows a more detailed perspective representation of the wheel suspension; and

FIG. 5 shows part of a wheel suspension according to the invention with a spindle.

### DETAILED DESCRIPTION

FIG. 1 shows a schematic side view of a wheel suspension according to the invention, the design of which is based on that of the so-called McPherson spring strut. The wheel suspension connects a wheel 5 of the motor vehicle to the body (not shown). The wheel 5 is mounted on a steering knuckle 1 by means of its horizontal axle so as to be rotatable. For its part, the steering knuckle 1 is mounted in a forked carrier 3 so as to be rotatable about a vertical axis 6. The vertical axis 6 passes through the center Z of the wheel 5 or very close to it. It is preferably at a distance from the center corresponding to less than 80% and particularly preferably less than 20% of the width of the wheel or rim. This rotatable mounting of the steering knuckle 1 shortens lever travel, which leads to the transmission of disturbing forces to the steering in customary wheel suspensions.

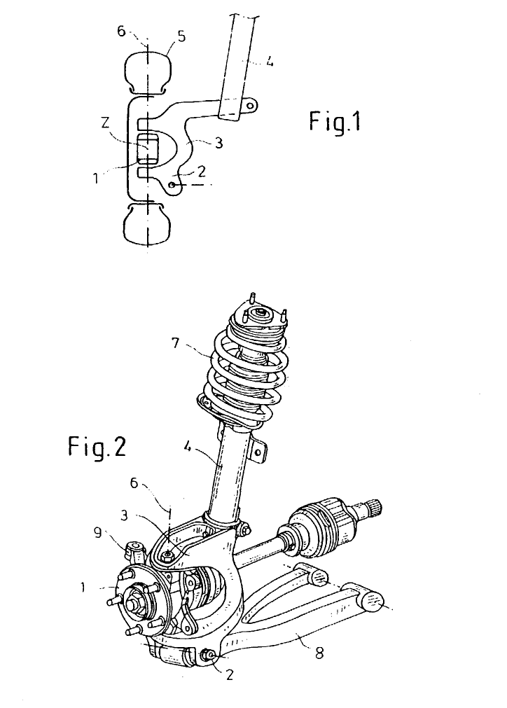

At its upper end, the carrier 3 is coupled to the body by means of the damper piston 4 of a spring strut. At its lower end, it is furthermore connected to the body or a subframe (not shown here) at a joint 2 via a preferably forked link 8 (FIG. 2), the link 8, for its part, being attached rotatably to the body or the subframe. This coupling of the carrier 3 to the body reduces these degrees of freedom, leading to additional isolation and increased rigidity.

FIG. 2 shows a possible configuration of the wheel suspension described above in perspective view. This shows, in particular, the construction of the spring strut from a damper piston 4 and a coil compression spring 7. Also visible, on the steering knuckle 1, is a lug 9, to which a further link element for a track rod can be attached.

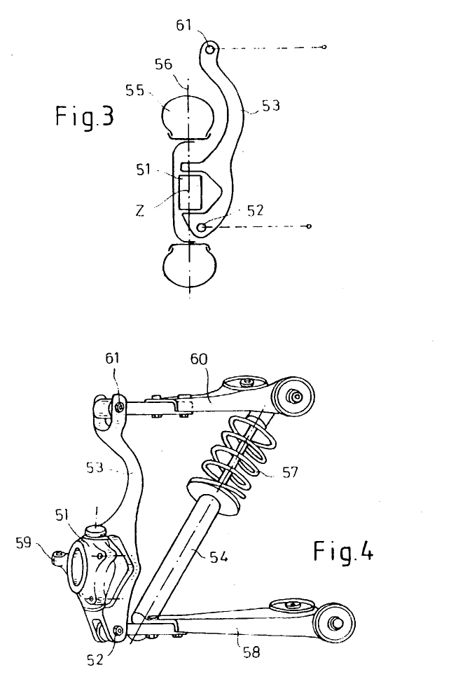

FIGS. 3 and 4 show another configuration of a wheel suspension according to the invention in a schematic side view. According to the invention, the steering knuckle 51, which supports a wheel 55 in such a way that it can rotate, is attached to the carrier 53 in such a way that it can rotate about a vertical axis 56. The carrier 53 is an arcuate fork, which is connected rotatably at its upper end, in a joint 61, and at its lower end, in a joint 52, to a transverse link 60 and a transverse link 58 respectively. Said transverse links 58, 60, for their part, are connected rotatably to the body.

As the perspective view in FIG. 4 shows, the lower transverse link 58 is coupled to the body by means of a spring/damper element containing a damper piston 54 and a spring 57. Also visible on the steering knuckle 51 is a lug 59, to which a further link element or track rod can be attached.

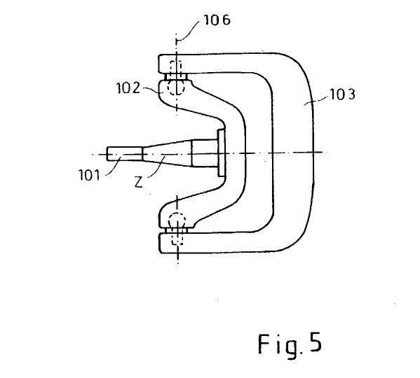

Finally, FIG. 5 shows a detail of a wheel suspension, in which the wheel is not secured in a steering knuckle but is secured on a spindle 101. The spindle 101 is supported by a U-shaped yoke 102, which, for its part, is secured on a U-shaped carrier 103 in such a way that it can rotate about the vertical axis 106. According to the invention, the vertical axis 106 in turn passes (approximately) through the center Z of the wheel suspension.

1. A wheel suspension for a motor vehicle, comprising:
a bearing element for a wheel axle, wherein said bearing element is mounted on a carrier in such a way that it can rotate relative to an essentially vertical axis, and the vertical axis passing close to the wheel center.

2. The wheel suspension as claimed in claim 1, wherein the carrier is connected at its lower end, in a joint, to a link coupled to the body or to a subframe.

3. The wheel suspension as claimed in claim 1, wherein the bearing element is a steering knuckle.

4. The wheel suspension as claimed in claim 2, wherein the bearing element is a steering knuckle.

5. The wheel suspension as claimed in claim 1, wherein the bearing element is a spindle.

6. The wheel suspension as claimed in claim 1, wherein the bearing element is a spindle.

7. The wheel suspension as claimed in claim 1, wherein the carrier is coupled to the body by means of a spring strut.

8. The wheel suspension as claimed in claim 2, wherein the carrier is coupled to the body by means of a spring strut.

9. The wheel suspension as claimed in claim 3, wherein the carrier is coupled to the body by means of a spring strut.

10. The wheel suspension as claimed in claim 4, wherein the carrier is coupled to the body by means of a spring strut.

11. The wheel suspension as claimed in claim 5, wherein the carrier is coupled to the body by means of a spring strut.

12. The wheel suspension as claimed in claim 6, wherein the carrier is coupled to the body by means of a spring strut.
